(19) United States
(12) Patent Application Publication
(10) Pub. No.: US 2022/0398662 A1
(43) Pub. Date: Dec. 15, 2022

(54) METHODS, SYSTEMS, AND DEVICES FOR FACILITATING EXCHANGE AND TRANSACTION OF CURRENCIES

(71) Applicants: Oluwaseyi Ogunsola, Katy, TX (US); Oluwatobi Gabriel Olorunsola, Gardena, CA (US); Samuel Oluseyi Fadipe, Frederick, MD (US); Taiwo Oluyemi Omotoso, Hillsboro, OR (US)

(72) Inventors: Oluwaseyi Ogunsola, Katy, TX (US); Oluwatobi Gabriel Olorunsola, Gardena, CA (US); Samuel Oluseyi Fadipe, Frederick, MD (US); Taiwo Oluyemi Omotoso, Hillsboro, OR (US)

(21) Appl. No.: 17/841,205

(22) Filed: Jun. 15, 2022

Related U.S. Application Data
(60) Provisional application No. 63/210,655, filed on Jun. 15, 2021.

(51) Int. Cl. G06Q 40/04

(52) U.S. Cl. CPC G06Q 40/04

(57) ABSTRACT

Disclosed herein is a method of facilitating exchange and transaction of currencies, in accordance with some embodiments. Accordingly, the method comprises receiving a request from a first user device, analyzing the request, identifying a second user based on the analyzing, establishing an interaction session between the first user device and a second user device associated with the second user based on the identifying, receiving a negotiated exchange rate between a first currency and a second currency from the first user device and the second user device, determining a second amount of the second currency based on the negotiated exchange rate and a first amount of the first currency, generating a first transaction order and a second transaction order based on the determining, and storing the first transaction order and the second transaction order.

### FIELD OF THE INVENTION

Generally, the present invention relates generally to data processing including but not limited to economics, finance, banking, currency exchange, and peer to peer communication. More specifically, the present disclosure relates to methods, systems, and devices for facilitating exchange and transaction of currencies.

### BACKGROUND OF THE INVENTION

The field of data processing is technologically important to several industries, business organizations, and/or individuals. In particular, the use of data processing is prevalent for facilitating global money transfer and currency exchange.

Existing techniques for facilitating global money transfer and currency exchange are deficient with regard to several aspects. For instance, current technologies specifically allow the fulfillment of an order by only a single user. As a result, different technologies are needed for allowing the fulfillment of the orders by multiple users. Further, current technologies specifically allow the global money transfer and the currency exchange with a predetermined exchange rate. As a result, different technologies are needed for allowing negotiation of the exchange rate between a buyer and a seller for allowing the global money transfer and the currency exchange. Moreover, current technologies allow for retrieving exchange rates on a daily basis. As a result, different technologies are needed for regularly retrieving exchange rates from a plurality of sources based on a schedule. Further, current technologies allow for the exchange of money from one particular user to another. As a result, different technologies are needed that feature a pool of users that may want to exchange money with multiple currencies and intermediate currency steps.

Therefore, there is a need for improved methods, systems, and devices for facilitating exchange and transaction of currencies that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating exchange and transaction of currencies, in accordance with some embodiments. Accordingly, the method may include a step of receiving, using a communication device, at least one request from at least one first user device associated with at least one first user. Further, the at least one request may include a request for exchanging at least one first amount of at least one first currency with at least one second currency. Further, the method may include a step of analyzing, using a processing device, the at least one request. Further, the method may include a step of identifying, using the processing device, at least one second user from a plurality of users based on the analyzing. Further, the at least one second user may be available for exchanging the at least one second currency with the at least one first amount of the at least one first currency. Further, the method may include a step of establishing, using the processing device, at least one interaction session between the at least one first user device and at least one second user device associated with the at least one second user based on the identifying. Further, the at least one first user and the at least one second user negotiate at least one exchange rate between the at least one first currency and the at least one second currency during the at least one interaction session. Further, the method may include a step of receiving, using the communication device, at least one negotiated exchange rate between the at least one first currency and the at least one second currency from the at least one first user device and the at least one second user device. Further, the receiving of the at least one negotiated exchange rate may include receiving the at least one negotiated exchange rate after the establishing of the at least one interaction session. Further, the method may include a step of determining, using the processing device, at least one second amount of the at least one second currency based on the at least one negotiated exchange rate and the at least one first amount of the at least one first currency. Further, the method may include a step of generating, using the processing device, at least one of a first transaction order and a second transaction order for at least one of the exchanging of the at least one first amount of the at least one first currency with the at least one second amount of the at least one second currency based on the determining of the at least one second amount of the at least one second currency. Further, the method may include a step of storing, using a storage device, at least one of the first transaction order and the second transaction order.

Further, disclosed herein is a method of facilitating exchange and transaction of currencies, in accordance with some embodiments. Accordingly, the method may include a step of receiving, using a communication device, at least one request from at least one first user device associated with at least one first user. Further, the at least one request may include a request for exchanging at least one first amount of at least one first currency with at least one second currency. Further, the method may include a step of analyzing, using a processing device, the at least one request. Further, the method may include a step of identifying, using the processing device, at least one second user from a plurality of users based on the analyzing. Further, the at least one second user may be available for exchanging the at least one second currency with the at least one first amount of the at least one first currency. Further, the method may include a step of establishing, using the processing device, at least one interaction session between the at least one first user device and at least one second user device associated with the at least one second user based on the identifying. Further, the at least one first user and the at least one second user negotiate at least one exchange rate between the at least one first currency and the at least one second currency during the at least one interaction session. Further, the method may include a step of retrieving, using a storage device, at least one exchange trend between the at least one first currency and the at least one second currency based on the identifying. Further, the method may include a step of analyzing, using the processing device, the at least one exchange trend using at least one machine learning model. Further, the method may include a step of generating, using the processing device, at least one suggested exchange rate between the at least one first currency and the at least one second currency based on the analyzing of the at least one exchange trend. Further, the method may include a step of transmitting, using the communication device, the at least one suggested exchange rate to the at least one first user device and the at least one second user device during the at least one interaction session. Further, the method may include a step of receiving, using the communication device, at least one negotiated exchange rate between the at least one first currency and the at least one second currency from the at least one first user device and the at least one second user device. Further, the receiving of the at least one negotiated exchange rate may include receiving the at least one negotiated exchange rate after the establishing of the at least one interaction session. Further, the method may include a step of determining, using the processing device, at least one second amount of the at least one second currency based on the at least one negotiated exchange rate and the at least one first amount of the at least one first currency. Further, the method may include a step of generating, using the processing device, at least one of a first transaction order and a second transaction order for at least one of the exchanging of the at least one first amount of the at least one first currency with the at least one second amount of the at least one second currency based on the determining of the at least one second amount of the at least one second currency. Further, the method may include a step of storing, using a storage device, at least one of the first transaction order and the second transaction order.

Further disclosed herein is a system for facilitating exchange and transaction of currencies, in accordance with some embodiments. Accordingly, the system may include a communication device configured for receiving at least one request from at least one first user device associated with at least one first user. Further, the at least one request may include a request for exchanging at least one first amount of at least one first currency with at least one second currency. Further, the communication device may be configured for receiving at least one negotiated exchange rate between the at least one first currency and the at least one second currency from the at least one first user device and at least one second user device. Further, the system may include a processing device communicatively coupled with the communication device. Further, the processing device may configured for analyzing the at least one request. Further, the processing device may be configured for identifying at least one second user from a plurality of users based on the analyzing. Further, the at least one second user may be available for exchanging the at least one second currency with the at least one first amount of the at least one first currency. Further, the processing device may be configured for establishing at least one interaction session between the at least one first user device and the at least one second user device associated with the at least one second user based on the identifying. Further, the at least one first user and the at least one second user negotiate at least one exchange rate between the at least one first currency and the at least one second currency during the at least one interaction session. Further, the receiving of the at least one negotiated exchange rate may include receiving the at least one negotiated exchange rate after the establishing of the at least one interaction session. Further, the processing device may be configured for determining at least one second amount of the at least one second currency based on the at least one negotiated exchange rate and the at least one first amount of the at least one first currency. Further, the processing device may be configured for generating at least one of a first transaction order and a second transaction order for at least one of the exchanging of the at least one first amount of the at least one first currency with the at least one second amount of the at least one second currency based on the determining of the at least one second amount of the at least one second currency. Further, the system may include a storage device communicatively coupled with the processing device. Further, the storage device may be configured for storing at least one of the first transaction order and the second transaction order.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating exchange and transaction of currencies, in accordance with some embodiments.

FIG. 3 is a block diagram of the system, in accordance with some embodiments.

FIG. 4 is a block diagram of the system, in accordance with some embodiments.

FIG. 5 is a block diagram of the system, in accordance with some embodiments.

FIG. 6 is a flowchart of a method of facilitating exchange and transaction of currencies, in accordance with some embodiments.

FIG. 7 is a flowchart of a method of suggesting exchange rates of the currencies to users for facilitating the exchange and the transaction of the currencies, in accordance with some embodiments.

FIG. 8 is a flowchart of a method of processing transactions between the users for facilitating the exchange and the transaction of the currencies, in accordance with some embodiments.

FIG. 9 is a flowchart of a method of transmitting exchange rates of the currencies to the users for facilitating the exchange and the transaction of the currencies, in accordance with some embodiments.

FIG. 10 is a flowchart of a method of transacting digital currencies with the currencies for facilitating the exchange and the transaction of the currencies, in accordance with some embodiments.

FIG. 11 is a flowchart of a method for determining conversion rates between the digital currencies and the currencies for facilitating the exchange and the transaction of the currencies, in accordance with some embodiments.

FIG. 12 is a flowchart of a method of facilitating exchange and transaction of currencies, in accordance with some embodiments.

FIG. 13 is a continuation flowchart of the method of facilitating the exchange and the transaction of the currencies, in accordance with some embodiments.

FIG. 14 is a flowchart of a method of processing transactions between the users for facilitating the exchange and the transaction of the currencies, in accordance with some embodiments.

FIG. 15 is a block diagram of a system for facilitating global money transfer and currency exchange, in accordance with some embodiments.

FIG. 16 is a flow chart of a method for facilitating global money transfer and currency exchange, in accordance with some embodiments.

FIG. 17 is a flow diagram of a method for facilitating global money transfer and currency exchange, in accordance with some embodiments.

FIG. 18 is a tabular representation illustrating comparison of the disclosed system with existing systems.

FIG. 19 is a tabular representation of features performed by the disclosed system, in accordance with some embodiments.

FIG. 20 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, and devices for facilitating exchange and transaction of currencies, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods, systems, and devices for facilitating exchange and transaction of currencies.

Further, the present disclosure describes methods and systems for facilitating global money transfer and currency exchange. Further, the disclosed system may be associated with a software platform (such as a software application and a website). Further, the disclosed system may be associated with a buyer-seller marketplace, platform, and interface for global money transfer and currency exchange where safety, security, simplicity, engaging, flexibility, and the human factor makes the experience superior to competitors or conventional money transfer models.

The disclosed system may be configured for facilitating global money transfer and currency exchange that provides the capability for connecting buyers and sellers for the exchange of two or more currencies. Further, the disclosed system may be configured for facilitating for exchange of two or more currencies at negotiable rates (independent of existing market rate). Further, the disclosed system may be configured for listing currency for exchange into another currency at a fixed or flexible rate. Yet further, the disclosed system may be configured for selling and/or buying two or more currencies at negotiable exchange rates that may be driven by the parties (buyers/sellers) involved in the transaction. Further, the disclosed system may be configured for real-time negotiation and currency transactions based on the mutually agreed rate between the parties involved. Further, the disclosed system may be configured for real-time currency transactions between multiple parties, at single or multiple exchange rates established by the parties involved. Moreover, the disclosed system may be configured for international currency exchange and transfer wherein there is no movement of funds across international borders. Further, the disclosed system may be configured for receiving payments and facilitating disbursement of funds in two or more currencies. Further, the disclosed system may be configured for tracking historical trends in exchange rates and providing competitive rate suggestions. Further, the disclosed system may be configured for facilitating private chat(s) and conversation(s) between parties prior/during/after currency transactions. In addition, the disclosed system may be configured for facilitating safe and secure currency transactions and exchanges between parties involved. Further, the disclosed system may be configured for securing user account details, personal profile, data, and transaction information. Further, the disclosed system may be configured for issuance of a sell and/or buy order upon agreement of a satisfactory exchange rate between the parties involved. Further, a user (buyer or seller) may be associated with a mobile wallet.

Additionally, the disclosed system may be configured for pulling of external rates. Further, the disclosed system may be configured for pulling exchange rates from several sources (like Expedia™ does for hotels) and displaying the exchange rates to users of the software platform. Further, the exchange rates (or rates) may be pulled on a scheduled basis, e.g. hourly or daily. That way, the disclosed system functions like an Expedia of currency exchange rates, or a currency realtor app. Yet further, the disclosed system may be configured for multi-user order fulfillment. Further, the disclosed system may allow multiple users to bid on whole or part of the currency offer. Further, requests may be satisfied partially or totally by a single user, or multiple users. Also, the requests may be fulfilled in single or multiple currency steps. Further, the software platform may provide multiple bid modes to the users. Moreover, the multiple bid modes may include public bidding mode and private bid mode. Further, the disclosed system may be configured for provisioning the users with private chat mode features. Further, the users may bid in public or make private offers to sellers. Further, the disclosed system may be configured for provisioning public chat and private communications. Further, the disclosed system may be associated with multi-currencies. In addition, the disclosed system may be associated with a pool or ring of users with multiple currencies and intermediate currency steps, e.g. dollars to GBP to Yen. Further, in the future, the multi-currency pool may include digital currency and barter. Further, the disclosed system may be associated with a digital currency. Further, the disclosed system may be configured for wallet balance conversion into a unit(s) of the invention-customized digital currency/barter. Additionally, the disclosed system may be configured for providing investment opportunities by trading the units of digital currency in foreign exchange, featuring a pool of users. Further, the disclosed system may be configured for generating exchange rates of the conversion of the digital currency to other multi-currencies (pulling from the Standard market trends of exchange). Further, the disclosed system may be configured for providing opportunities to purchase fractions of the digital currency for investments or savings within user(s) wallet(s). Moreover, the disclosed system may be configured for associating a small fee with the exchange rate to be paid by the buyer. Further, the disclosed system may be configured for exchange of money without moving currency. Yet further, remittance may not be required.

Further, the present disclosure describes a method for facilitating global money transfer and currency exchange. Further, the method may include receiving, using a communication device, user details from at least one first user device associated with at least one first user. Further, the method may include processing, using a processing device, the user details to generate a user profile associated with the at least one first user. Yet further, the method may include receiving, using the communication device a request from the at least one first user device. Further, the method may include receiving, using the communication device, exchanges rates from an input device. Moreover, the method may include transmitting, using the communication device, the exchange rates to the at least one first user device. Further, the method may include receiving, using the communication device, an exchange request from the at least one first user device. Further, the method may include transmitting, using the communication device, the exchange request to at least one second user device associated with at least one second user. Moreover, the method may include receiving, using the communication device, a negotiation from the at least one second user device. Further, the method may include transmitting, using the communication device, the negotiation to the at least one first user device. Further, the method may include receiving, using the communication device, a confirmation corresponding to the negotiation from the at least one first user device. In addition, the method may include processing, using the processing device, the exchange request, the negotiation, and the confirmation to generate a transaction alert. Further, the method may include transmitting, using the communication device, the transaction alert to at least one of the at least one first user device and the at least one second user device. Further, the method may include storing, using a storage device, at least one of the user details, the user profile, the exchange request, the negotiation and the transaction alert.

Further, the present disclosure describes a system for facilitating global money transfer and currency exchange. Further, the system may include a communication device configured for receiving user details from at least one first user device associated with at least one first user. Further, the communication device may be configured for receiving a request from the at least one first user device. Further, the communication device may be configured for receiving exchange rates from an input device. Yet further, the communication device may be configured for transmitting the exchange rates to the at least one first user device. Further, the communication device may be configured for receiving an exchange request from the at least one first user device. Further, the communication device may be configured for transmitting the exchange request to at least one second user device associated with at least one second user. Moreover, the communication device may be configured for receiving a negotiation from the at least one second user device. Further, the communication device may be configured for transmitting the negotiation to the at least one first user device. Further, the communication device may be configured for receiving a confirmation corresponding to the negotiation from the at least one first user device. In addition, the communication device may be configured for transmitting a transaction alert to at least one of the at least one first user device and the at least one second user device. Further, the system may include a processing device configured for processing the user details to generate a user profile associated with the at least one first user. Further, the processing device may be configured for processing the exchange request, the negotiation, and the confirmation to generate the transaction alert. Additionally, the system may include a storage device configured for storing at least one of the user details, the user profile, the exchange request, the negotiation, the transaction alert.

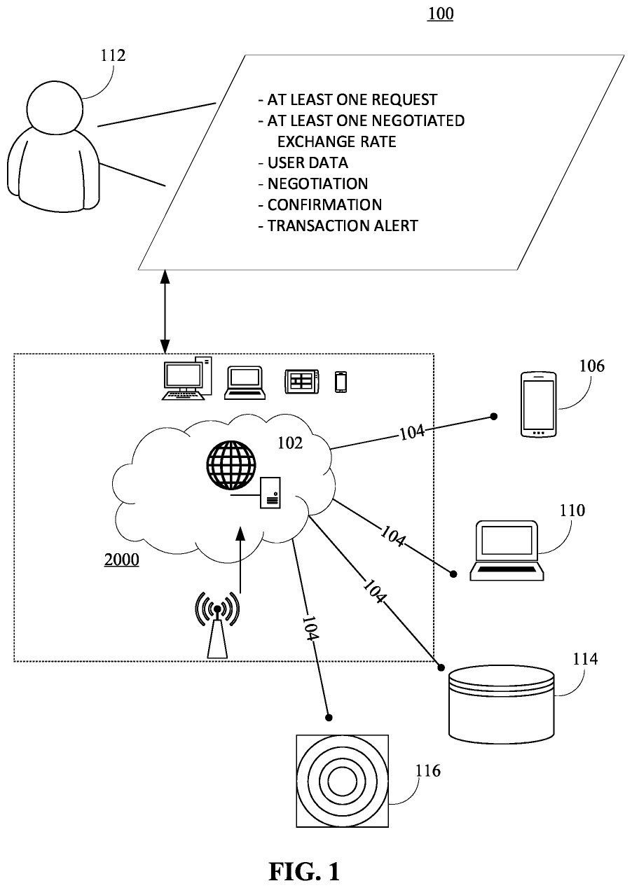

FIG. 1 is an illustration of an online platform 100 consistent with various embodiments of the present disclosure. By way of non-limiting example, the online platform 100 to facilitate exchange and transaction of currencies may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, first users, second users, administrators, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 2000.

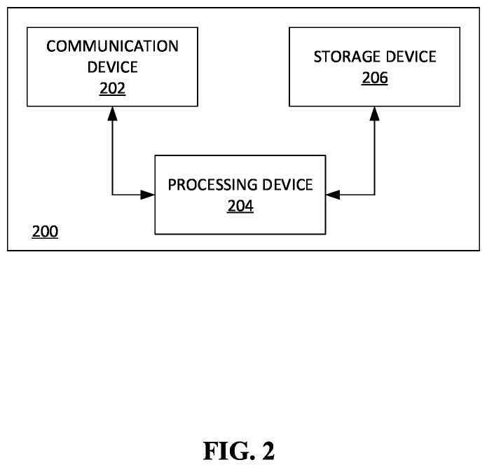

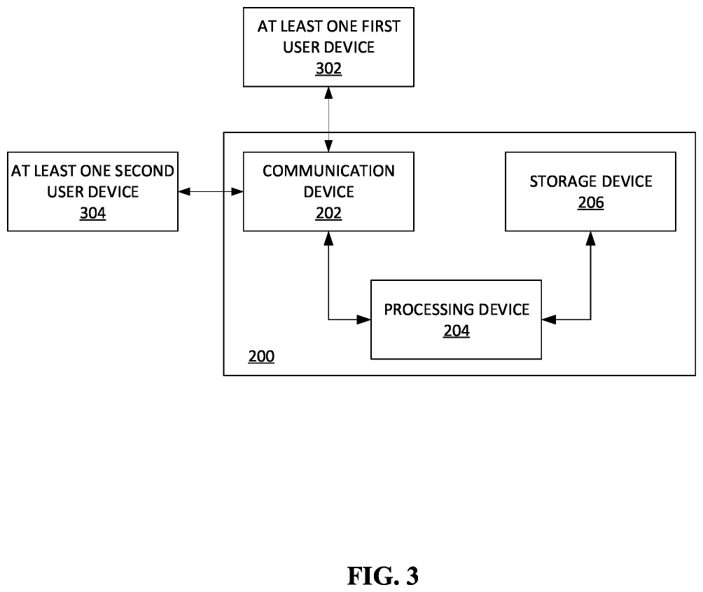

FIG. 2 is a block diagram of a system 200 for facilitating exchange and transaction of currencies, in accordance with some embodiments. Accordingly, the system 200 may include a communication device 202 configured for receiving at least one request from at least one first user device 302, as shown in FIG. 3, associated with at least one first user. Further, the at least one first user may include an individual, an institution, an organization, etc. Further, the at least one first user device 302 may include a computing device, a client device, etc. Further, the at least one request may include a request for exchanging at least one first amount of at least one first currency with at least one second currency. Further, the communication device 202 may be configured for receiving at least one negotiated exchange rate between the at least one first currency and the at least one second currency from the at least one first user device 302 and at least one second user device 304, as shown in FIG. 3. Further, the at least one second user device 304 may include a computing device, a client device, etc. Further, the at least one negotiated exchange rate may be a currency exchange rate negotiated for the at least one first currency and the at least one second currency between the at least one first user and at least one second user. Further, the at least one second user may include an individual, an institution, an organization, etc. Further, the at least one first currency and the at least one second currency may include USD, GBP, INR, Euro, etc.

Further, the system 200 may include a processing device 204 communicatively coupled with the communication device 202. Further, the processing device 204 may be configured for analyzing the at least one request. Further, the processing device 204 may be configured for identifying the at least one second user from a plurality of users based on the analyzing. Further, the at least one second user may be available for exchanging the at least one second currency with the at least one first amount of the at least one first currency. Further, the processing device 204 may be configured for establishing at least one interaction session between the at least one first user device 302 and the at least one second user device 304 associated with the at least one second user based on the identifying. Further, the at least one interaction session may include a chat session, a call session, a video call session, etc. Further, the at least one first user and the at least one second user negotiate at least one exchange rate between the at least one first currency and the at least one second currency during the at least one interaction session. Further, the receiving of the at least one negotiated exchange rate may include receiving the at least one negotiated exchange rate after the establishing of the at least one interaction session. Further, the processing device 204 may be configured for determining at least one second amount of the at least one second currency based on the at least one negotiated exchange rate and the at least one first amount of the at least one first currency. Further, the processing device 204 may be configured for generating at least one of a first transaction order and a second transaction order for at least one of the exchanging of the at least one first amount of the at least one first currency with the at least one second amount of the at least one second currency based on the determining of the at least one second amount of the at least one second currency.

Further, the system 200 may include a storage device 206 communicatively coupled with the processing device 204. Further, the storage device 206 may be configured for storing at least one of the first transaction order and the second transaction order.

Further, in some embodiments, the analyzing of the at least one request may include analyzing the at least one request using at least one machine learning model. Further, the at least one machine learning model may be trained for selecting the at least one second user from the plurality of users available for exchanging a plurality of currencies with the at least one first user. Further, each user of the plurality of users may be associated with a currency exchange preference and a currency amount preference. Further, the currency exchange preference may include an acceptable currency from the plurality of currencies and an exchangeable currency from the plurality of currencies. Further, the currency preference amount may include an acceptable amount for the acceptable currency and an exchangeable amount of the exchangeable currency for the acceptable amount of the acceptable currency. Further, the selecting of the at least one second user may be based on maximizing a conversion rate of the at least one first currency into the at least one second currency. Further, the identifying of the at least one second user may be based on the selecting of the at least one second user.

Further, in some embodiments, the storage device 206 may be configured for retrieving at least one exchange trend between the at least one first currency and the at least one second currency based on the identifying. Further, the processing device 204 may be configured for analyzing the at least one exchange trend using at least one machine learning model. Further, the processing device 204 may be configured for generating at least one suggested exchange rate between the at least one first currency and the at least one second currency based on the analyzing of the at least one exchange trend. Further, the communication device 202 may be configured for transmitting the at least one suggested exchange rate to the at least one first user device 302 and the at least one second user device 304 during the at least one interaction session. Further, the at least one machine learning model may be trained for predicting a future exchange rate between the at least one first currency and the at least one second currency based on the at least one exchange trend and at least one currency exchange market data associated with at least one currency exchange market. Further, the generating of the at least one suggested exchange rate may be based on the predicting. Further, the storage device 206 may be configured for retrieving the at least one currency exchange market data.

Further, in some embodiments, the storage device 206 may be configured for retrieving at least one first financial information associated with the at least one first user and at least one second financial information associated with the at least one second user based on the at least one request. Further, the at least one first financial information may include a debit card number, a credit card number, a bank account detail, digital wallet information, etc. Further, the at least one second financial information may include a debit card number, a credit card number, a bank account detail, digital wallet information, etc. Further, the processing device 204 may be configured for processing a transaction of the at least one first amount of the at least one first currency from at least one first user account associated with the at least one first user to at least one second user account associated with the at least one second user based on the first transaction order, the at least one first financial information, and the at least one second financial information. Further, the processing device 204 may be configured for processing a transaction of the at least one second amount of the at least one second currency from the at least one second user account to the at least one first user account based on the second transaction order, the at least one first financial information, and the at least one second financial information.

Further, in an embodiment, the processing of the transaction of the at least one first amount may include processing a transaction of the at least one first amount of the at least one first currency from the at least one first user account to at least one first account and a transaction of the at least one first amount of the at least one first currency from at least one second account to the at least one second user account. Further, the at least one first account may include a first barter account and the at least one second account may include a second barter account. Further, the first barter account may be associated with the at least one first currency and the second barter account may be associated with the at least one second currency.

Further, in an embodiment, the processing of the transaction of the at least one second amount may include processing a transaction of the at least one second amount of the at least one second currency from the at least one second user account to the at least one second account and a transaction of the at least one second amount of the at least one second currency from the at least one first account to the at least one first user account.

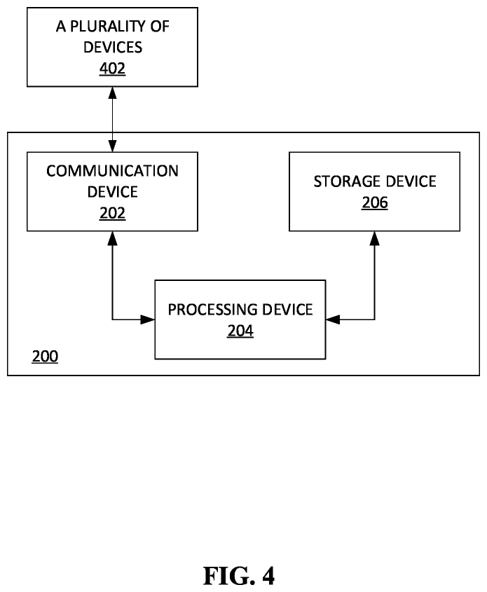

Further, in some embodiments, the communication device 202 may be configured for receiving a plurality of current exchange rates between the at least one first currency and the at least one second currency from a plurality of devices 402, as shown in FIG. 4. Further, the plurality of devices 402 may include a client device, a computing device, a server, etc. Further, the receiving of the plurality of current exchange rates may include receiving the plurality of current exchange rates after at least one period of time. Further, the communication device 202 may be configured for transmitting the plurality of exchange rates to the at least one first user device 302 and the at least one second user device 304 during the at least one interaction session.

Further, in some embodiments, the at least one request may include a request for transacting the at least one first amount of the at least one first currency. Further, the storage device 206 may be configured for retrieving at least one first financial information associated with the at least one first user based on the at least one request. Further, the processing device 204 may be configured for processing a transaction of the at least one first amount of the at least one first currency using at least one amount of at least one digital currency based on the at least one first financial information. Further, the at least one digital currency may include a cryptocurrency token, etc.

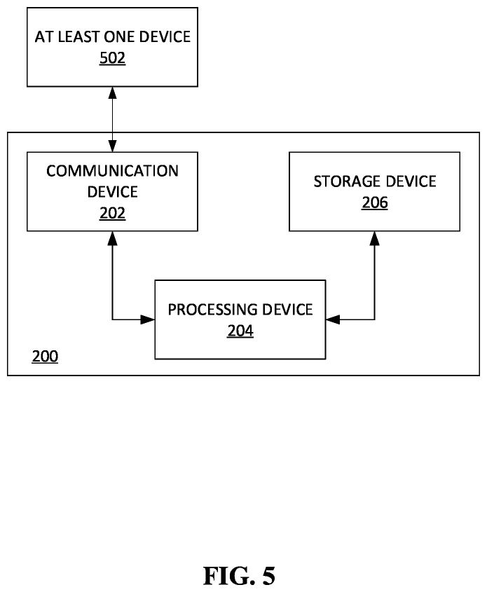

Further, in an embodiment, the communication device 202 may be configured for receiving at least one first exchange trend of the at least one first currency from at least one device 502, as shown in FIG. 5. Further, the at least one first device 502 may include a client device, a computing device, a server, etc. Further, the processing device 204 may be configured for analyzing the at least one first exchange trend. Further, the processing device 204 may be configured for determining at least one conversion rate between the at least one first currency and the at least one digital currency based on the analyzing of the at least one first exchange rate. Further, the processing device 204 may be configured for determining the at least one amount of the at least one digital currency based on the at least one first amount of the at least one first currency and the at least one conversion rate. Further, the processing of the transaction of the at least one first amount of the at least one first currency using the at least one amount of the at least one digital currency may be further based on the determining of the at least one amount of the at least one digital currency.

Further, in an embodiment, the processing device 204 may be configured for minting the at least one amount of the at least one digital currency based on the determining of the at least one amount of the at least one digital currency. Further, the processing of the transaction of the at least one first amount of the at least one first currency using the at least one amount of the at least one digital currency based on the minting.

FIG. 3 is a block diagram of the system 200, in accordance with some embodiments.

FIG. 4 is a block diagram of the system 200, in accordance with some embodiments.

FIG. 5 is a block diagram of the system 200, in accordance with some embodiments.

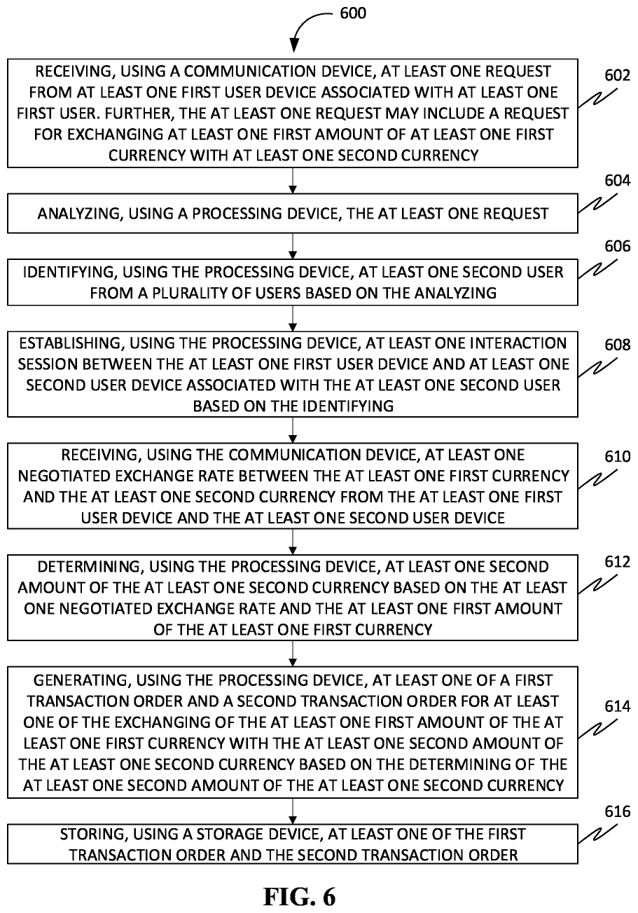

FIG. 6 is a flowchart of a method 600 of facilitating exchange and transaction of currencies, in accordance with some embodiments. Accordingly, at 602, the method 600 may include receiving, using a communication device, at least one request from at least one first user device associated with at least one first user. Further, the at least one request may include a request for exchanging at least one first amount of at least one first currency with at least one second currency.

Further, at 604, the method 600 may include analyzing, using a processing device, the at least one request.

Further, at 606, the method 600 may include identifying, using the processing device, at least one second user from a plurality of users based on the analyzing. Further, the at least one second user may be available for exchanging the at least one second currency with the at least one first amount of the at least one first currency.

Further, at 608, the method 600 may include establishing, using the processing device, at least one interaction session between the at least one first user device and at least one second user device associated with the at least one second user based on the identifying. Further, the at least one first user and the at least one second user negotiate at least one exchange rate between the at least one first currency and the at least one second currency during the at least one interaction session.

Further, at 610, the method 600 may include receiving, using the communication device, at least one negotiated exchange rate between the at least one first currency and the at least one second currency from the at least one first user device and the at least one second user device. Further, the receiving of the at least one negotiated exchange rate may include receiving the at least one negotiated exchange rate after the establishing of the at least one interaction session.

Further, at 612, the method 600 may include determining, using the processing device, at least one second amount of the at least one second currency based on the at least one negotiated exchange rate and the at least one first amount of the at least one first currency.

Further, at 614, the method 600 may include generating, using the processing device, at least one of a first transaction order and a second transaction order for at least one of the exchanging of the at least one first amount of the at least one first currency with the at least one second amount of the at least one second currency based on the determining of the at least one second amount of the at least one second currency.

Further, at 616, the method 600 may include storing, using a storage device, at least one of the first transaction order and the second transaction order.

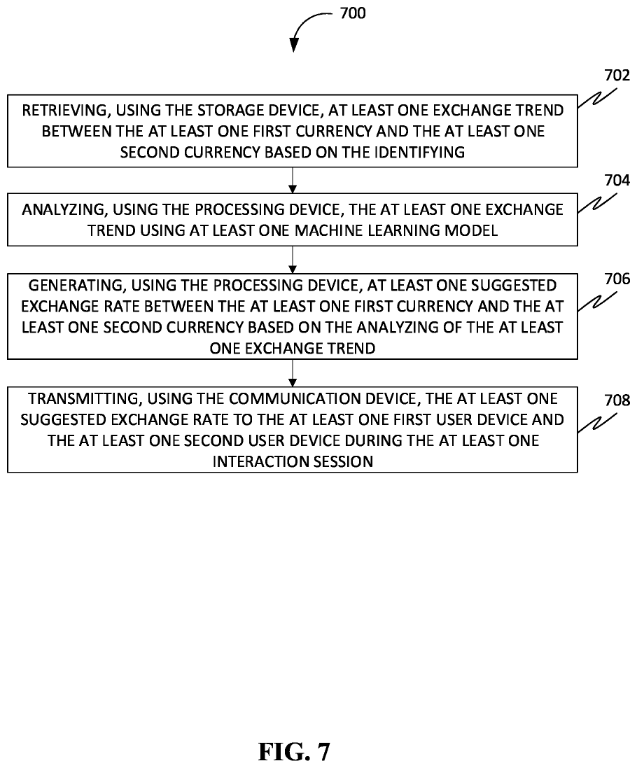

FIG. 7 is a flowchart of a method 700 of suggesting exchange rates of the currencies to users for facilitating the exchange and the transaction of the currencies, in accordance with some embodiments. Accordingly, at 702, the method 700 may include retrieving, using the storage device, at least one exchange trend between the at least one first currency and the at least one second currency based on the identifying.

Further, at 704, the method 700 may include analyzing, using the processing device, the at least one exchange trend using at least one machine learning model.

Further, at 706, the method 700 may include generating, using the processing device, at least one suggested exchange rate between the at least one first currency and the at least one second currency based on the analyzing of the at least one exchange trend.

Further, at 708, the method 700 may include transmitting, using the communication device, the at least one suggested exchange rate to the at least one first user device and the at least one second user device during the at least one interaction session.

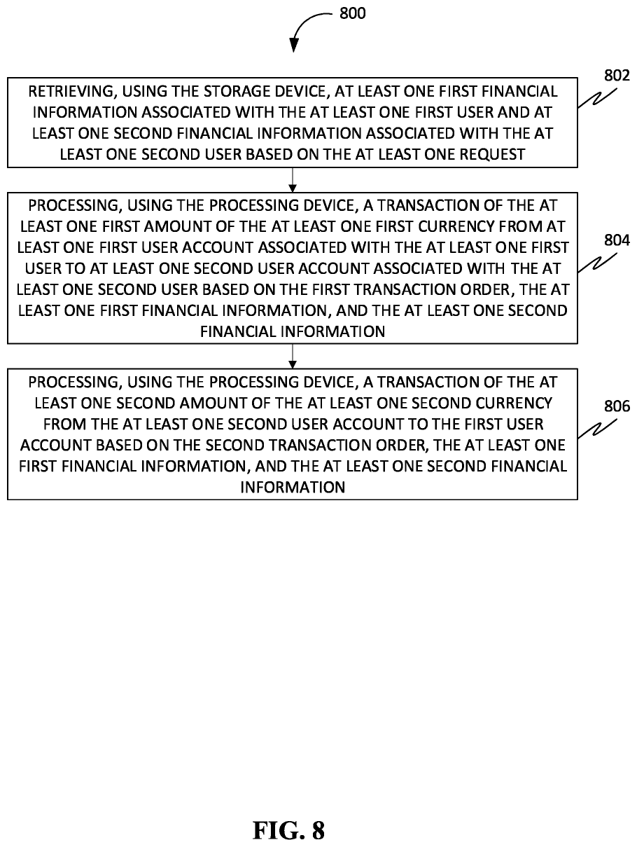

FIG. 8 is a flowchart of a method 800 of processing transactions between the users for facilitating the exchange and the transaction of the currencies, in accordance with some embodiments. Accordingly, at 802, the method 800 may include retrieving, using the storage device, at least one first financial information associated with the at least one first user and at least one second financial information associated with the at least one second user based on the at least one request.

Further, at 804, the method 800 may include processing, using the processing device, a transaction of the at least one first amount of the at least one first currency from at least one first user account associated with the at least one first user to at least one second user account associated with the at least one second user based on the first transaction order, the at least one first financial information, and the at least one second financial information.

Further, at 806, the method 800 may include processing, using the processing device, a transaction of the at least one second amount of the at least one second currency from the at least one second user account to the at least one first user account based on the second transaction order, the at least one first financial information, and the at least one second financial information.

Further, in some embodiments, the processing of the transaction of the at least one first amount may include processing a transaction of the at least one first amount of the at least one first currency from the at least one first user account to at least one first account and a transaction of the at least one first amount of the at least one first currency from at least one second account to the at least one second user account.

Further, in an embodiment, the processing of the transaction of the at least one second amount may include processing a transaction of the at least one second amount of the at least one second currency from the at least one second user account to the at least one second account and a transaction of the at least one second amount of the at least one second currency from the at least one first account to the at least one first user account.

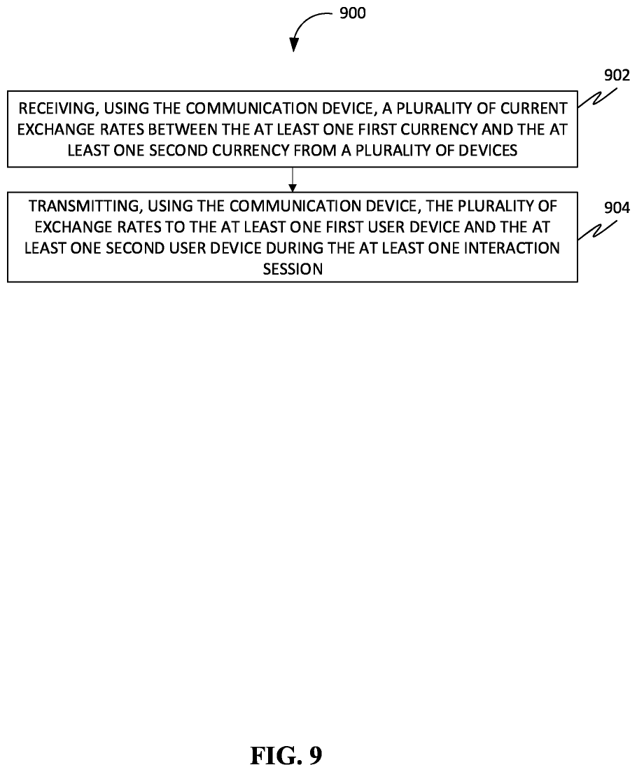

FIG. 9 is a flowchart of a method 900 of transmitting exchange rates of the currencies to the users for facilitating the exchange and the transaction of the currencies, in accordance with some embodiments. Accordingly, at 902, the method 900 may include receiving, using the communication device, a plurality of current exchange rates between the at least one first currency and the at least one second currency from a plurality of devices. Further, the receiving of the plurality of current exchange rates may include receiving the plurality of current exchange rates after at least one period of time.

Further, at 904, the method 900 may include transmitting, using the communication device, the plurality of exchange rates to the at least one first user device and the at least one second user device during the at least one interaction session.

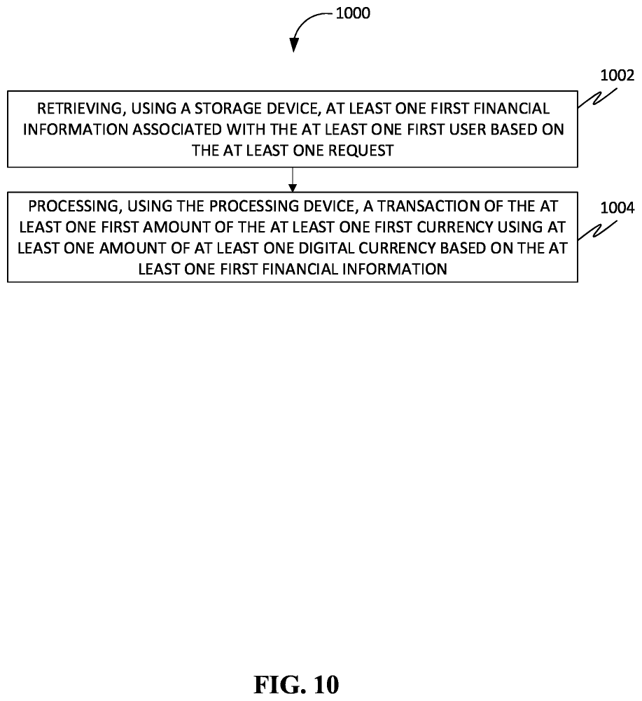

FIG. 10 is a flowchart of a method 1000 of transacting digital currencies with the currencies for facilitating the exchange and the transaction of the currencies, in accordance with some embodiments. Further, the at least one request may include a request for transacting the at least one first amount of the at least one first currency. Further, at 1002, the method 1000 may include retrieving, using a storage device, at least one first financial information associated with the at least one first user based on the at least one request.

Further, at 1004, the method 1000 may include processing, using the processing device, a transaction of the at least one first amount of the at least one first currency using at least one amount of at least one digital currency based on the at least one first financial information.

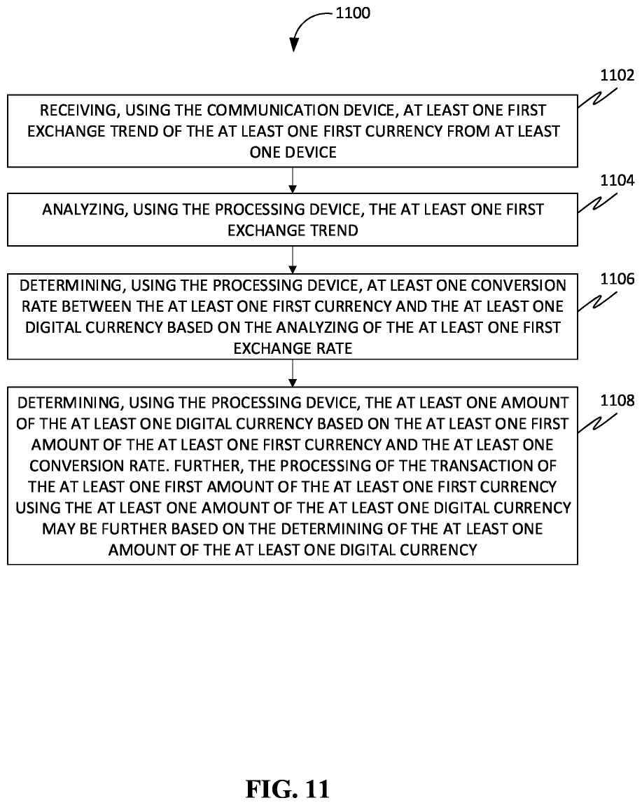

FIG. 11 is a flowchart of a method 1100 for determining conversion rates between the digital currencies and the currencies for facilitating the exchange and the transaction of the currencies, in accordance with some embodiments. Accordingly, at 1102, the method 1100 may include receiving, using the communication device, at least one first exchange trend of the at least one first currency from at least one device.

Further, at 1104, the method 1100 may include analyzing, using the processing device, the at least one first exchange trend.

Further, at 1106, the method 1100 may include determining, using the processing device, at least one conversion rate between the at least one first currency and the at least one digital currency based on the analyzing of the at least one first exchange rate.

Further, at 1108, the method 1100 may include determining, using the processing device, the at least one amount of the at least one digital currency based on the at least one first amount of the at least one first currency and the at least one conversion rate. Further, the processing of the transaction of the at least one first amount of the at least one first currency using the at least one amount of the at least one digital currency may be further based on the determining of the at least one amount of the at least one digital currency.

In further embodiments, the method 1100 may include minting, using the processing device, the at least one amount of the at least one digital currency based on the determining of the at least one amount of the at least one digital currency. Further, the processing of the transaction of the at least one first amount of the at least one first currency using the at least one amount of the at least one digital currency based on the minting.

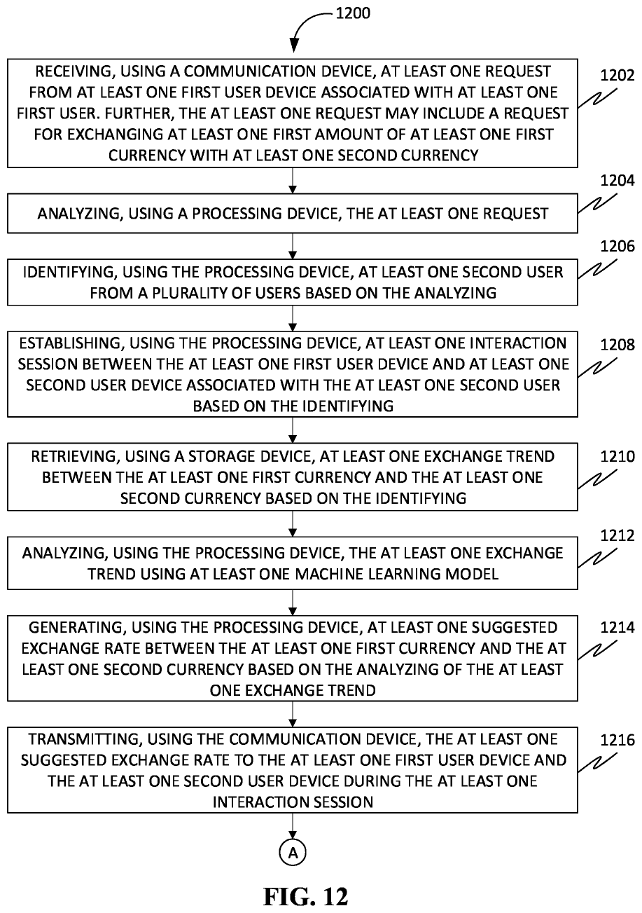

FIG. 12 is a flowchart of a method 1200 of facilitating exchange and transaction of currencies, in accordance with some embodiments. Accordingly, at 1202, the method 1200 may include receiving, using a communication device, at least one request from at least one first user device associated with at least one first user. Further, the at least one request may include a request for exchanging at least one first amount of at least one first currency with at least one second currency.

Further, at 1204, the method 1200 may include a step of analyzing, using a processing device, the at least one request.

Further, at 1206, the method 1200 may include identifying, using the processing device, at least one second user from a plurality of users based on the analyzing. Further, the at least one second user may be available for exchanging the at least one second currency with the at least one first amount of the at least one first currency.

Further, at 1208, the method 1200 may include establishing, using the processing device, at least one interaction session between the at least one first user device and at least one second user device associated with the at least one second user based on the identifying. Further, the at least one first user and the at least one second user negotiate at least one exchange rate between the at least one first currency and the at least one second currency during the at least one interaction session.

Further, at 1210, the method 1200 may include retrieving, using a storage device, at least one exchange trend between the at least one first currency and the at least one second currency based on the identifying.

Further, at 1212, the method 1200 may include analyzing, using the processing device, the at least one exchange trend using at least one machine learning model.

Further, at 1214, the method 1200 may include generating, using the processing device, at least one suggested exchange rate between the at least one first currency and the at least one second currency based on the analyzing of the at least one exchange trend.

Further, at 1216, the method 1200 may include transmitting, using the communication device, the at least one suggested exchange rate to the at least one first user device and the at least one second user device during the at least one interaction session.

Further, at 1218, the method 1200 may include receiving, using the communication device, at least one negotiated exchange rate between the at least one first currency and the at least one second currency from the at least one first user device and the at least one second user device. Further, the receiving of the at least one negotiated exchange rate may include receiving the at least one negotiated exchange rate after the establishing of the at least one interaction session.

Further, at 1220, the method 1200 may include determining, using the processing device, at least one second amount of the at least one second currency based on the at least one negotiated exchange rate and the at least one first amount of the at least one first currency.

Further, at 1222, the method 1200 may include generating, using the processing device, at least one of a first transaction order and a second transaction order for at least one of the exchanging of the at least one first amount of the at least one first currency with the at least one second amount of the at least one second currency based on the determining of the at least one second amount of the at least one second currency.

Further, at 1224, the method 1200 may include storing, using a storage device, at least one of the first transaction order and the second transaction order.

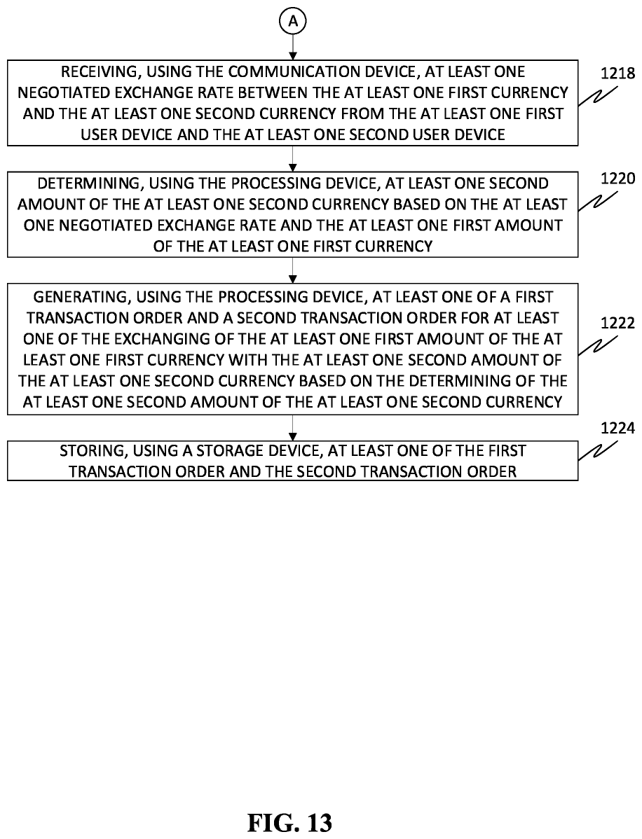

FIG. 13 is a continuation flowchart of the method 1200 of facilitating the exchange and the transaction of the currencies, in accordance with some embodiments.

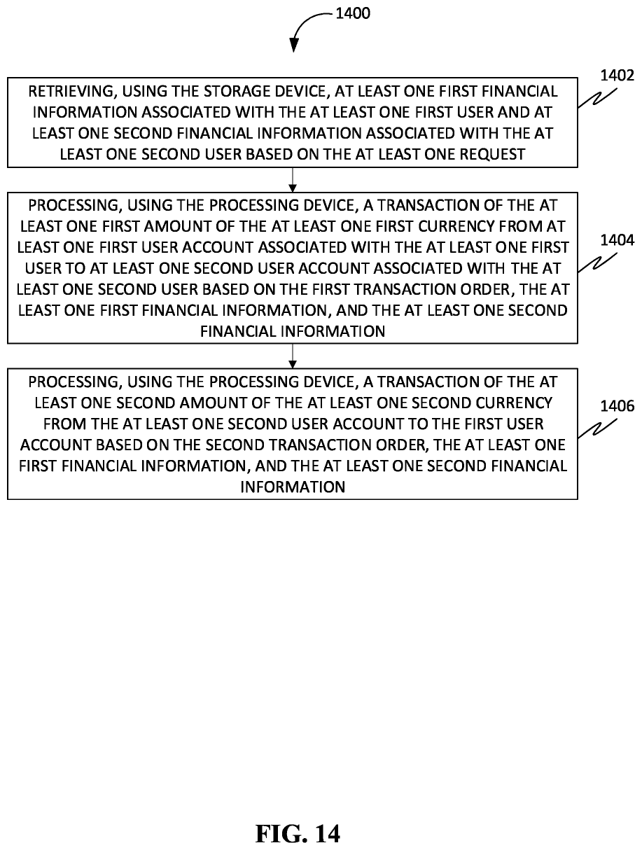

FIG. 14 is a flowchart of a method 1400 of processing transactions between the users for facilitating the exchange and the transaction of the currencies, in accordance with some embodiments. Accordingly, at 1402, the method 1400 may include retrieving, using the storage device, at least one first financial information associated with the at least one first user and at least one second financial information associated with the at least one second user based on the at least one request.

Further, at 1404, the method 1400 may include processing, using the processing device, a transaction of the at least one first amount of the at least one first currency from at least one first user account associated with the at least one first user to at least one second user account associated with the at least one second user based on the first transaction order, the at least one first financial information, and the at least one second financial information

Further, at 1406, the method 1400 may include processing, using the processing device, a transaction of the at least one second amount of the at least one second currency from the at least one second user account to the at least one first user account based on the second transaction order, the at least one first financial information, and the at least one second financial information.

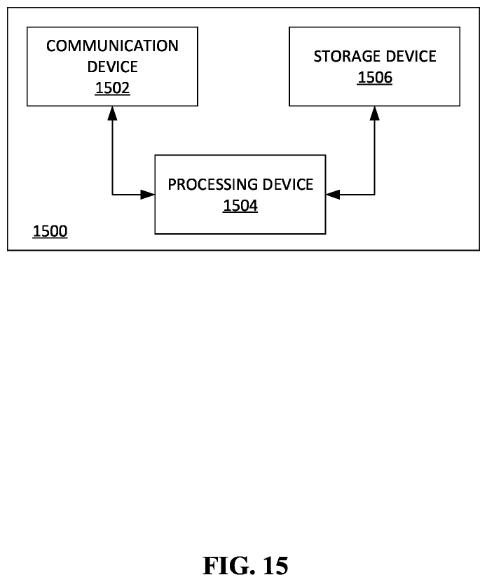

FIG. 15 is a block diagram of a system 1500 for facilitating global money transfer and currency exchange, in accordance with some embodiments. Accordingly, the system 1500 may include a communication device 1502 configured for receiving user details from at least one first user device associated with at least one first user. Further, the user details may include a name, an address, an email address, age, contact number, etc. Further, the communication device 1502 may be configured for receiving a request from the at least one first user device. Yet further, the request may correspond to the at least one first user that may want to transfer money and exchange currency. Further, the at least one first user may exchange the currency from an initial currency to a final currency. Further, the initial currency and the final currency may include one of USD, GBP, INR, Euros, etc. Further, in an embodiment, at least one of the initial currency and the final currency may include a digital currency. Moreover, the initial currency may be different from the final currency. Further, the communication device 1502 may be configured for receiving exchange rates from an input device. Further, the input device may include a web server. Further, the exchange rates may be associated with the initial currency and the final currency. Further, the communication device 1502 may be configured for transmitting the exchange rates to the at least one first user device. Additionally, the communication device 1502 may be configured for receiving an exchange request from the at least one first user device. Further, the exchange request may include an exchange offer rate associated with the initial currency and the final currency, at which the at least one first user may want to exchange the currency. Further, the communication device 1502 may be configured for transmitting the exchange request to at least one second user device associated with at least one second user. Further, the at least one second user may include an individual, an institution, and an organization. In addition, the at least one second user may include one of the buyer and the seller. Further, in the instance, the at least one second user may include the seller. Further, the at least one second user device may include a laptop, a smartphone, a tablet, a personal computer, and so on. Further, the communication device 1502 may be configured for receiving a negotiation from the at least one second user device. Further, the negotiation may include an exchange value corresponding to the final currency. Further, the communication device 1502 may be configured for transmitting the negotiation to the at least one first user device. Moreover, the communication device 1502 may be configured for receiving a confirmation corresponding to the negotiation from the at least one first user device. Further, the confirmation may include a positive confirmation and a negative confirmation. Further, the positive confirmation may correspond to agreement of the at least one first user to exchange the currency with the at least one second user based on the negotiation. Yet further, the negative confirmation may correspond to disagreement of the at least one first user to exchange the currency with the at least one second user. Further, the communication device 1502 may be configured for transmitting a transaction alert to at least one of the at least one first user device and the at least one second user device.

Further, the system 1500 may include a processing device 1504 configured for processing the user details to generate a user profile associated with the at least one first user. Further, the user profile may be associated with a user name and a password that may be used by the at least one first user to login into the user profile. Moreover, the at least one first user may include an individual, an institution, and an organization. Further, the at least one first user may include one of a buyer and a seller. Further, in an instance, the at least one first user may include the buyer. Further, the at least one first user device may include a laptop, a smartphone, a tablet, a personal computer, and so on. Further, the processing device 1504 may be configured for processing the exchange request, the negotiation, and the confirmation to generate the transaction alert. Additionally, the transaction alert may facilitate the exchange of the currency between the at least one first user and the at least one second user. Further, the transaction alert may include transaction information such as transaction ID and transaction time.

Further, the system 1500 may include a storage device 1506 configured for storing at least one of the user details, the exchange rates, the exchange request, the confirmation, the user profile, the pulled rates from external sources, the negotiation and the transaction alert.

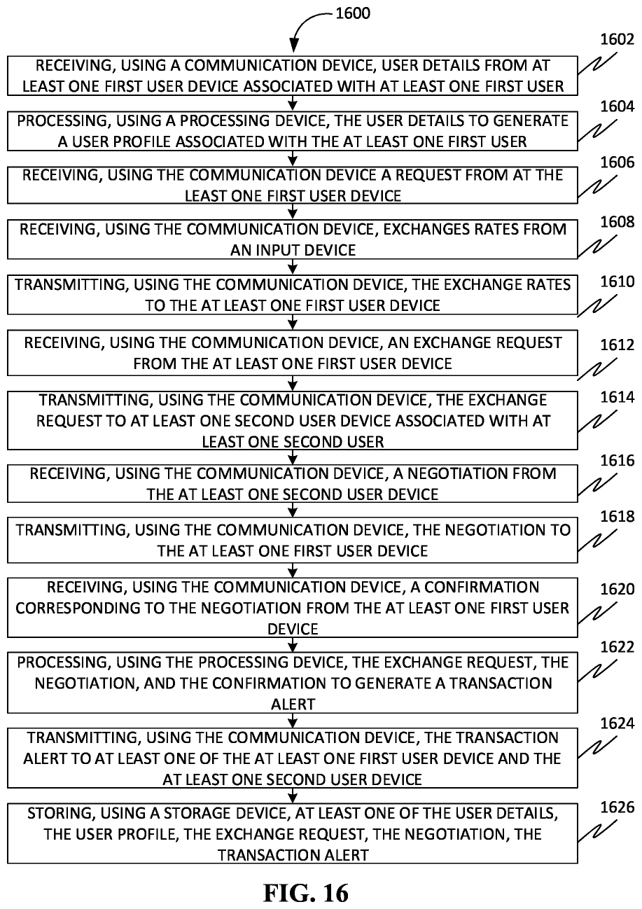

FIG. 16 is a flow chart of a method 1600 for facilitating global money transfer and currency exchange, in accordance with some embodiments. Accordingly, at 1602, the method 1600 may include receiving, using a communication device, user details from at least one first user device associated with at least one first user. Further, the user details may include a name, an address, an email address, age, contact number, etc.

Further, at 1604, the method 1600 may include processing, using a processing device, the user details to generate a user profile associated with the at least one first user. Yet further, the user profile may be associated with a user name and a password that may be used by the at least one first user to login into the user profile. Further, the at least one first user may include an individual, an institution, and an organization. Further, the at least one first user may include one of a buyer and a seller. Further, the at least one first user may include multiple users. Moreover, in an instance, the at least one first user may include the buyer. Further, the at least one first user device may include a laptop, a smartphone, a tablet, a personal computer, and so on. Further, the user profile may include a user wallet which can host multiple currencies including digital currency.

Further, at 1606, the method 1600 may include receiving, using the communication device, a request from the at least one first user device. Further, the request may correspond to the at least one first user that may want to transfer money and exchange currency. Additionally, the at least one first user may exchange the currency from an initial currency to a final currency. Further, the request may include an amount corresponding in part or whole to the money (or currency) that the at least one user may want to exchange (or invest). Further, the initial currency and the final currency may include one of USD, CAD, GBP, INR, Euros, CNY, JPY, AED, etc. Further, the initial currency may be different from the final currency. Additionally, in an embodiment, at least one of the initial currency and the final currency may include a digital currency.

Further, at 1608, the method 1600 may include receiving, using the communication device, exchanges rates from an input device. Yet further, the input device may include a web server. Additionally, the exchange rates may be associated with the initial currency and the final currency. Further, the input device may include web servers, application servers, data servers (or database), etc. that may be associated with a plurality of external sources (such as external cross platforms). Further, the disclosed system may be configured for functioning as a currency realtor application based on the receiving of the exchange rates from the input device.

Further, at 1610, the method 1600 may include transmitting, using the communication device, the exchange rates to the at least one first user device.

Additionally, at 1612, the method 1600 may include receiving, using the communication device, an exchange request from the at least one first user device. Further, the exchange request may include an exchange offer rate associated with the initial currency and the final currency, at which the at least one first user may want to exchange the currency.

Further, at 1614, the method 1600 may include transmitting, using the communication device, the exchange request to at least one second user device associated with at least one second user. In addition, the at least one second user may include an individual, an institution, and an organization that may want to exchange money or currency with the at least one first user from the final currency to the initial currency and vice-versa. Further, the at least one second user may include multiple users. Further, the at least one second user may include one of the buyer and the seller. Further, in the instance, the at least one second user may include the seller. Additionally, the at least one second user device may include a laptop, a smartphone, a tablet, a personal computer, and so on.

Moreover, at 1616, the method 1600 may include receiving, using the communication device, a negotiation from the at least one second user device. Further, the negotiation may include an exchange value corresponding to the final currency.

Further, at 1618, the method 1600 may include transmitting, using the communication device, the negotiation to the at least one first user device.

Additionally, at 1620, the method 1600 may include receiving, using the communication device, a confirmation corresponding to the negotiation from the at least one first user device. Further, the confirmation may include a positive confirmation and a negative confirmation. Further, the positive confirmation may correspond to agreement of the at least one first user to exchange the currency with the at least one second user based on the negotiation. Further, the negative confirmation may correspond to disagreement of the at least one first user to exchange the currency with the at least one second user.

In addition, at 1622, the method 1600 may include processing, using the processing device, the exchange request, the negotiation, and the confirmation to generate a transaction alert. Further, the transaction alert may facilitate the exchange of the currency between the at least one first user and the at least one second user. Further, the transaction alert may include transaction information such as transaction ID and transaction time.

Further, at 1624, the method 1600 may include transmitting, using the communication device, the transaction alert to at least one of the at least one first user device and the at least one second user device.

Further, at 1626, the method 1600 may include storing, using a storage device, at least one of the user details, the user profile, the exchange request, the pulled rates from external sources, the negotiation, the request, the confirmation, the transaction alert.

Moreover, in some embodiments, the method 1600 may include receiving, using the communication device, an investment/exchange request from the at least one first user device. Further, the investment/exchange request may indicate that the at least one user may want to invest money. Further, the method 1600 may include analyzing, using the processing device, the investment/exchange request and the request. Further, the method 1600 may include adding, using the processing device, digital currency to the user wallet based on the analyzing of the investment/exchange request and the request.

Further, in some embodiments, the at least one first user may communicate with the at least one second user using multiple modes via private chat, public bid, group, multi-modes, etc.

Further, in some embodiments, the method 1600 may facilitate fractional bidding between the at least one first user and at least one second user.

Moreover, in some embodiments, the method 1600 may include multi-currency intermediate steps. Further, the multi-currency intermediate steps may include the at least one first user exchanging multiple currencies with one or more second users. For instance, the at least one first user may exchange currency from USD to GBP to Yen with the one or more second users.

Further, in some embodiments, the method 1600 may include storing transaction history on a database.

Additionally, in some embodiments, the method 1600 may include storing negotiation history on a database.

Further, in some embodiments, the method 1600 may include storing transaction flow including multiple rates, users, etc. on a database.

Further, in some embodiments, the method 1600 may include storing rates (exchange rates) from other platforms on a database. Further, in some embodiments, the method 1600 may include receiving, using the communication request, a bidding request from the at least one first user device. Further, the bidding request may include one of a private bidding request and a public bidding request. Further, the private bidding may facilitate making private offers to the at least one second user (or sellers) by the at least one first user (or buyers). Further, the public bidding may facilitate making private offers to the at least one second user (or sellers) by the at least one first user (or buyers). Additionally, the bidding request may include an offer from the at least one first user to the at least one second user for performing the exchange of the currency. Further, the method 1600 may include transmitting, using the communication device, the bidding request to the at least one second user device. Further, the method 1600 may include receiving, using the communication device, at least one bidding response corresponding to the bidding request from the at least one second user device. In addition, the at least one bidding response may include an exchange offer value (or negotiation) at which the at least one second user may want to exchange the currency. Further, the method 1600 may include analyzing, using the processing device, the bidding request and the at least one bidding response. Further, the generating of the transaction alert may be based on the analyzing the bidding request and the at least one bidding response.

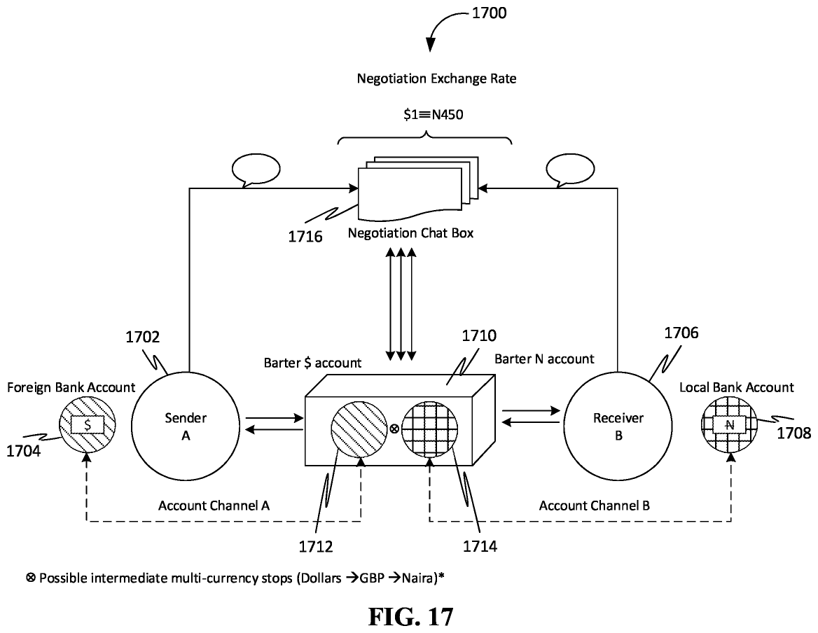

FIG. 17 is a flow diagram of a method 1700 for facilitating global money transfer and currency exchange, in accordance with some embodiments. Accordingly, a sender 1702 may be associated with a foreign bank account 1704. Further, a receiver 1706 may be associated with a local bank account 1708. Further, the method 1700 may include receiving an offer from the sender 1702 into a barter box 1710 that may include a barter $ account 1712 associated with the sender 1702 and a barter N account 1714 associated with the receiver 1706. Further, the barter $ account 1712 may communicate with the foreign bank account 1704 using an account channel A. Further, the barter N account 1714 may communicate with the local bank account 1708 using an account channel B. Additionally, the barter box 1710 may facilitate negotiation between the sender 1702 and the receiver 1706 for the exchange of the currency. Further, the method 1700 may include a negotiation chat box 1716 for facilitating the negotiation based on sending and receiving messages between the sender 1702 and the receiver 1706.

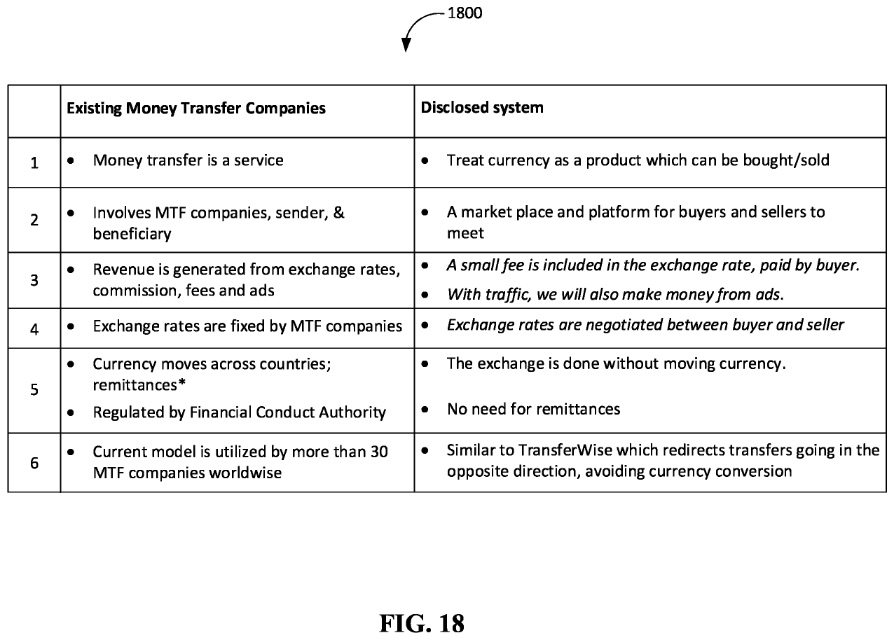

FIG. 18 is a tabular representation 1800 illustrating comparison of the disclosed system with existing systems.

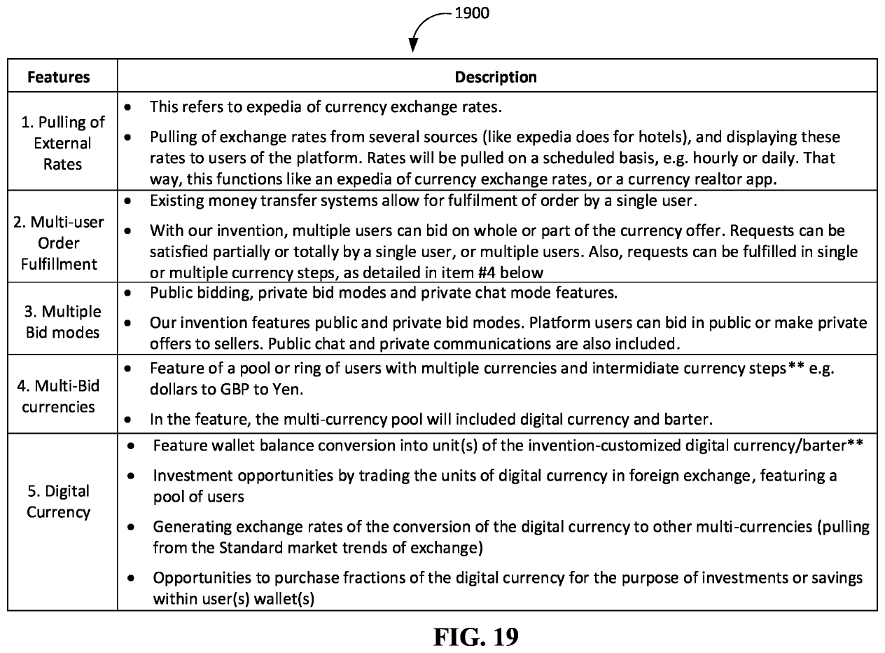

FIG. 19 is a tabular representation 1900 of features performed by the disclosed system, in accordance with some embodiments.

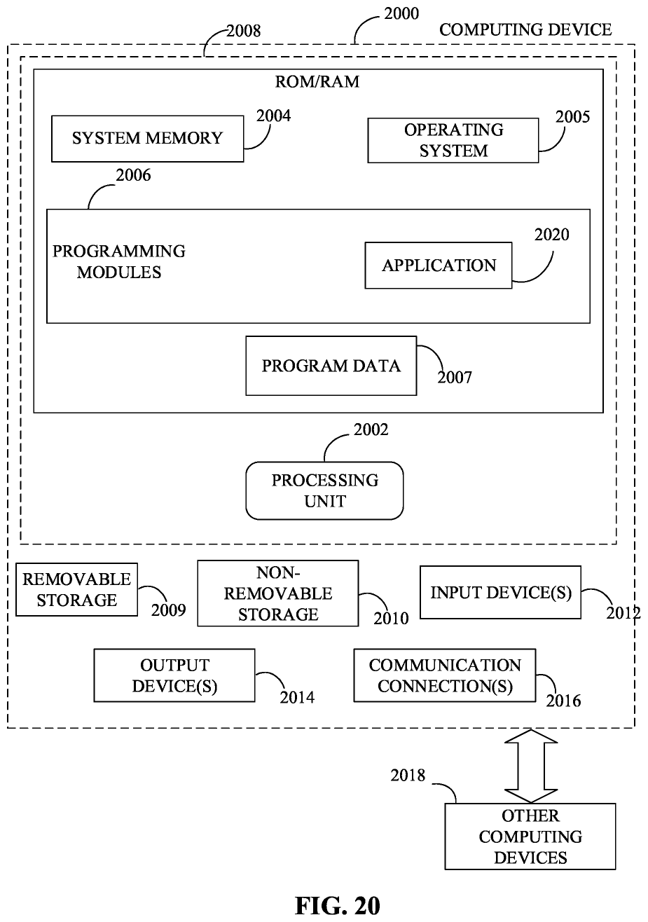

With reference to FIG. 20, a system consistent with an embodiment of the disclosure may include a computing device or cloud service, such as computing device 2000. In a basic configuration, computing device 2000 may include at least one processing unit 2002 and a system memory 2004. Depending on the configuration and type of computing device, system memory 2004 may comprise, but is not limited to, volatile (e.g. random-access memory (RAM)), non-volatile (e.g. read-only memory (ROM)), flash memory, or any combination. System memory 2004 may include operating system 2005, one or more programming modules 2006, and may include a program data 2007. Operating system 2005, for example, may be suitable for controlling computing device 2000's operation. In one embodiment, programming modules 2006 may include image-processing module, machine learning module. Furthermore, embodiments of the disclosure may be practiced in conjunction with a graphics library, other operating systems, or any other application program and is not limited to any particular application or system. This basic configuration is illustrated in FIG. 20 by those components within a dashed line 2008.

Computing device 2000 may have additional features or functionality. For example, computing device 2000 may also include additional data storage devices (removable and/or non-removable) such as, for example, magnetic disks, optical disks, or tape. Such additional storage is illustrated in FIG. 20 by a removable storage 2009 and a non-removable storage 2010. Computer storage media may include volatile and non-volatile, removable and non-removable media implemented in any method or technology for storage of information, such as computer-readable instructions, data structures, program modules, or other data. System memory 2004, removable storage 2009, and non-removable storage 2010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2000. Any such computer storage media may be part of device 2000. Computing device 2000 may also have input device(s) 2012 such as a keyboard, a mouse, a pen, a sound input device, a touch input device, a location sensor, a camera, a biometric sensor, etc. Output device(s) 2014 such as a display, speakers, a printer, etc. may also be included. The aforementioned devices are examples and others may be used.

Computing device 2000 may also contain a communication connection 2016 that may allow device 2000 to communicate with other computing devices 2018, such as over a network in a distributed computing environment, for example, an intranet or the Internet. Communication connection 2016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2004, including operating system 2005. While executing on processing unit 2002, programming modules 2006 (e.g., application 2020 such as a media player) may perform processes including, for example, one or more stages of methods, algorithms, systems, applications, servers, databases as described above. The aforementioned process is an example, and processing unit 2002 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method for facilitating exchange and transaction of currencies, the method comprising:
receiving, using a communication device, at least one request from at least one first user device associated with at least one first user, wherein the at least one request comprises a request for exchanging at least one first amount of at least one first currency with at least one second currency;
analyzing, using a processing device, the at least one request;
identifying, using the processing device, at least one second user from a plurality of users based on the analyzing, wherein the at least one second user is available for exchanging the at least one second currency with the at least one first amount of the at least one first currency;
establishing, using the processing device, at least one interaction session between the at least one first user device and at least one second user device associated with the at least one second user based on the identifying, wherein the at least one first user and the at least one second user negotiate at least one exchange rate between the at least one first currency and the at least one second currency during the at least one interaction session;
receiving, using the communication device, at least one negotiated exchange rate between the at least one first currency and the at least one second currency from the at least one first user device and the at least one second user device, wherein the receiving of the at least one negotiated exchange rate comprises receiving the at least one negotiated exchange rate after the establishing of the at least one interaction session;
determining, using the processing device, at least one second amount of the at least one second currency based on the at least one negotiated exchange rate and the at least one first amount of the at least one first currency;
generating, using the processing device, at least one of a first transaction order and a second transaction order for at least one of the exchanging of the at least one first amount of the at least one first currency with the at least one second amount of the at least one second currency based on the determining of the at least one second amount of the at least one second currency; and
storing, using a storage device, at least one of the first transaction order and the second transaction order.

2. The method of claim 1 further comprising:
retrieving, using the storage device, at least one exchange trend between the at least one first currency and the at least one second currency based on the identifying;
analyzing, using the processing device, the at least one exchange trend using at least one machine learning model;
generating, using the processing device, at least one suggested exchange rate between the at least one first currency and the at least one second currency based on the analyzing of the at least one exchange trend; and
transmitting, using the communication device, the at least one suggested exchange rate to the at least one first user device and the at least one second user device during the at least one interaction session.

3. The method of claim 1 further comprising:
retrieving, using the storage device, at least one first financial information associated with the at least one first user and at least one second financial information associated with the at least one second user based on the at least one request;
processing, using the processing device, a transaction of the at least one first amount of the at least one first currency from at least one first user account associated with the at least one first user to at least one second user account associated with the at least one second user based on the first transaction order, the at least one first financial information, and the at least one second financial information; and
processing, using the processing device, a transaction of the at least one second amount of the at least one second currency from the at least one second user account to the at least one first user account based on the second transaction order, the at least one first financial information, and the at least one second financial information.

4. The method of claim 3, wherein the processing of the transaction of the at least one first amount comprises processing a transaction of the at least one first amount of the at least one first currency from the at least one first user account to at least one first account and a transaction of the at least one first amount of the at least one first currency from at least one second account to the at least one second user account.

5. The method of claim 4, wherein the processing of the transaction of the at least one second amount comprises processing a transaction of the at least one second amount of the at least one second currency from the at least one second user account to the at least one second account and a transaction of the at least one second amount of the at least one second currency from the at least one first account to the at least one first user account.

6. The method of claim 1 further comprising:
receiving, using the communication device, a plurality of current exchange rates between the at least one first currency and the at least one second currency from a plurality of devices, wherein the receiving of the plurality of current exchange rates comprises receiving the plurality of current exchange rates after at least one period of time; and
transmitting, using the communication device, the plurality of exchange rates to the at least one first user device and the at least one second user device during the at least one interaction session.

7. The method of claim 1, wherein the at least one request comprises a request for transacting the at least one first amount of the at least one first currency, wherein the method further comprises:
retrieving, using a storage device, at least one first financial information associated with the at least one first user based on the at least one request; and
processing, using the processing device, a transaction of the at least one first amount of the at least one first currency using at least one amount of at least one digital currency based on the at least one first financial information.

8. The method of claim 7 further comprising:
receiving, using the communication device, at least one first exchange trend of the at least one first currency from at least one device;
analyzing, using the processing device, the at least one first exchange trend;
determining, using the processing device, at least one conversion rate between the at least one first currency and the at least one digital currency based on the analyzing of the at least one first exchange rate; and
determining, using the processing device, the at least one amount of the at least one digital currency based on the at least one first amount of the at least one first currency and the at least one conversion rate, wherein the processing of the transaction of the at least one first amount of the at least one first currency using the at least one amount of the at least one digital currency is further based on the determining of the at least one amount of the at least one digital currency.

9. The method of claim 8 further comprising minting, using the processing device, the at least one amount of the at least one digital currency based on the determining of the at least one amount of the at least one digital currency, wherein the processing of the transaction of the at least one first amount of the at least one first currency using the at least one amount of the at least one digital currency based on the minting.

10. A method for facilitating exchange and transaction of currencies, the method comprising:
receiving, using a communication device, at least one request from at least one first user device associated with at least one first user, wherein the at least one request comprises a request for exchanging at least one first amount of at least one first currency with at least one second currency;
analyzing, using a processing device, the at least one request;
identifying, using the processing device, at least one second user from a plurality of users based on the analyzing, wherein the at least one second user is available for exchanging the at least one second currency with the at least one first amount of the at least one first currency;
establishing, using the processing device, at least one interaction session between the at least one first user device and at least one second user device associated with the at least one second user based on the identifying, wherein the at least one first user and the at least one second user negotiate at least one exchange rate between the at least one first currency and the at least one second currency during the at least one interaction session;
retrieving, using a storage device, at least one exchange trend between the at least one first currency and the at least one second currency based on the identifying;
analyzing, using the processing device, the at least one exchange trend using at least one machine learning model;
generating, using the processing device, at least one suggested exchange rate between the at least one first currency and the at least one second currency based on the analyzing of the at least one exchange trend;
transmitting, using the communication device, the at least one suggested exchange rate to the at least one first user device and the at least one second user device during the at least one interaction session;
receiving, using the communication device, at least one negotiated exchange rate between the at least one first currency and the at least one second currency from the at least one first user device and the at least one second user device, wherein the receiving of the at least one negotiated exchange rate comprises receiving the at least one negotiated exchange rate after the establishing of the at least one interaction session;
determining, using the processing device, at least one second amount of the at least one second currency based on the at least one negotiated exchange rate and the at least one first amount of the at least one first currency;
generating, using the processing device, at least one of a first transaction order and a second transaction order for at least one of the exchanging of the at least one first amount of the at least one first currency with the at least one second amount of the at least one second currency based on the determining of the at least one second amount of the at least one second currency; and
storing, using the storage device, at least one of the first transaction order and the second transaction order.

11. The method of claim 10 further comprising:
retrieving, using the storage device, at least one first financial information associated with the at least one first user and at least one second financial information associated with the at least one second user based on the at least one request;
processing, using the processing device, a transaction of the at least one first amount of the at least one first currency from at least one first user account associated with the at least one first user to at least one second user account associated with the at least one second user based on the first transaction order, the at least one first financial information, and the at least one second financial information; and
processing, using the processing device, a transaction of the at least one second amount of the at least one second currency from the at least one second user account to the at least one first user account based on the second transaction order, the at least one first financial information, and the at least one second financial information.

12. A system for facilitating exchange and transaction of currencies, the system comprising:
a communication device configured for:
receiving at least one request from at least one first user device associated with at least one first user, wherein the at least one request comprises a request for exchanging at least one first amount of at least one first currency with at least one second currency; and
receiving at least one negotiated exchange rate between the at least one first currency and the at least one second currency from the at least one first user device and at least one second user device;
a processing device communicatively coupled with the communication device, wherein the processing device is configured for:
analyzing the at least one request;
identifying at least one second user from a plurality of users based on the analyzing, wherein the at least one second user is available for exchanging the at least one second currency with the at least one first amount of the at least one first currency;
establishing at least one interaction session between the at least one first user device and the at least one second user device associated with the at least one second user based on the identifying, wherein the at least one first user and the at least one second user negotiate at least one exchange rate between the at least one first currency and the at least one second currency during the at least one interaction session, wherein the receiving of the at least one negotiated exchange rate comprises receiving the at least one negotiated exchange rate after the establishing of the at least one interaction session;
determining at least one second amount of the at least one second currency based on the at least one negotiated exchange rate and the at least one first amount of the at least one first currency; and
generating at least one of a first transaction order and a second transaction order for at least one of the exchanging of the at least one first amount of the at least one first currency with the at least one second amount of the at least one second currency based on the determining of the at least one second amount of the at least one second currency; and
a storage device communicatively coupled with the processing device, wherein the storage device is configured for storing at least one of the first transaction order and the second transaction order.

13. The system of claim 12, wherein the storage device is further configured for retrieving at least one exchange trend between the at least one first currency and the at least one second currency based on the identifying, wherein the processing device is further configured for:
analyzing the at least one exchange trend using at least one machine learning model; and
generating at least one suggested exchange rate between the at least one first currency and the at least one second currency based on the analyzing of the at least one exchange trend, wherein the communication device is further configured for transmitting the at least one suggested exchange rate to the at least one first user device and the at least one second user device during the at least one interaction session.

14. The system of claim 12, wherein the storage device is further configured for retrieving at least one first financial information associated with the at least one first user and at least one second financial information associated with the at least one second user based on the at least one request, wherein the processing device is further configured for:
processing a transaction of the at least one first amount of the at least one first currency from at least one first user account associated with the at least one first user to at least one second user account associated with the at least one second user based on the first transaction order, the at least one first financial information, and the at least one second financial information; and
processing a transaction of the at least one second amount of the at least one second currency from the at least one second user account to the at least one first user account based on the second transaction order, the at least one first financial information, and the at least one second financial information.

15. The system of claim 14, wherein the processing of the transaction of the at least one first amount comprises processing a transaction of the at least one first amount of the at least one first currency from the at least one first user account to at least one first account and a transaction of the at least one first amount of the at least one first currency from at least one second account to the at least one second user account.

16. The system of claim 15, wherein the processing of the transaction of the at least one second amount comprises processing a transaction of the at least one second amount of the at least one second currency from the at least one second user account to the at least one second account and a transaction of the at least one second amount of the at least one second currency from the at least one first account to the at least one first user account.

17. The system of claim 12, wherein the communication device is further configured for:
receiving a plurality of current exchange rates between the at least one first currency and the at least one second currency from a plurality of devices, wherein the receiving of the plurality of current exchange rates comprises receiving the plurality of current exchange rates after at least one period of time; and
transmitting the plurality of exchange rates to the at least one first user device and the at least one second user device during the at least one interaction session.

18. The system of claim 12, wherein the at least one request comprises a request for transacting the at least one first amount of the at least one first currency, wherein the storage device is further configured for retrieving at least one first financial information associated with the at least one first user based on the at least one request, wherein the processing device is further configured for processing a transaction of the at least one first amount of the at least one first currency using at least one amount of at least one digital currency based on the at least one first financial information.

19. The system of claim 18, wherein the communication device is further configured for receiving at least one first exchange trend of the at least one first currency from at least one device, wherein the processing device is further configured for:
analyzing the at least one first exchange trend;
determining at least one conversion rate between the at least one first currency and the at least one digital currency based on the analyzing of the at least one first exchange rate; and
determining the at least one amount of the at least one digital currency based on the at least one first amount of the at least one first currency and the at least one conversion rate, wherein the processing of the transaction of the at least one first amount of the at least one first currency using the at least one amount of the at least one digital currency is further based on the determining of the at least one amount of the at least one digital currency.

20. The system of claim 19, wherein the processing device is further configured for minting the at least one amount of the at least one digital currency based on the determining of the at least one amount of the at least one digital currency, wherein the processing of the transaction of the at least one first amount of the at least one first currency using the at least one amount of the at least one digital currency based on the minting.
